(19) United States
(12) Patent Application Publication
(10) Pub. No.: US 2026/0143281 A1
(43) Pub. Date: May 21, 2026

(54) AUDIO-VISUAL DEVICE AND METHOD OF OPERATING THEREOF

(71) Applicant: Y.E. Hub Armenia LLC, Yerevan (AM)

(72) Inventors: Mikhail VANCHUGOV, Moscow (RU); Leonid PANFILOV, Moscow (RU); Sergei SOGUROV, Moscow (RU)

(21) Appl. No.: 19/390,211

(22) Filed: Nov. 14, 2025

(30) Foreign Application Priority Data
Nov. 15, 2024 (RU) 2024134286

(51) Int. Cl. H04R 3/00; G06F 3/0346; H04R 1/02; H04R 1/40; H04R 3/12

(52) U.S. Cl. CPC H04R 3/005; G06F 3/0346; H04R 1/028; H04R 1/403; H04R 1/406; H04R 3/12; H04R 2201/401; H04R 2499/15

(57) ABSTRACT

An audio-visual device and method of operating thereof. The audio-visual device includes a body and a display adjustably connected to the body such that a position of the display can be adjusted relative to the body. The audio-visual device has two speakers, housed within the body, with one of the speakers being adjustable. The audio-visual device further includes two microphone arrays with a first array being positioned on a first section of the display and a second array being positioned on a second section of the display. The audio-visual device further includes a sensor configured to detect the position of the display and based on the detected position, the adjustable speaker is selectively configured and at least one of the two microphone arrays are selectively enabled.

### CROSS-REFERENCE

The present application claims priority to Russian Patent Application No. 2024134286, entitled “Audio-Visual Device and Method of Operating Thereof”, filed Nov. 15, 2024, the entirety of which is incorporated herein by reference.

### TECHNICAL FIELD

The present technology relates to an audio-visual device having an adjustably connected display, and to a method for operating thereof.

### BACKGROUND

Audio-visual devices with adjustable displays are widely used in various fields, such as entertainment systems, video conferencing, and personal computing. These devices typically feature a display screen that is adjustably connected to the main body of the device, which houses the speakers, microphones, and other electronic components. While the adjustability of the display offers flexibility in terms of viewing angles and user comfort, it introduces several challenges related to the quality of audio capture and sound reproduction.

One issue associated with known devices involves sound blockage and distortion caused by the adjustable display. Typically, the speakers are positioned on the front or side or the main body, which becomes obstructed when the display is tilted or adjusted. This obstruction can dampen or block the sound waves, reducing the overall audio quality leading to a suboptimal listening experience. In some cases, the positioning of the display may cause reverberations or echoes which further degrades sound clarity.

Another challenge arises with the placement of microphones. Microphones are often positioned to optimize voice capture. However, when the display is moved, it can alter the distance and angle of the microphone relative to the user's voice, impairing voice recognition and capture, resulting in poor voice pick up, increased background noises, and/or muffled sound.

Therefore, there is a desire for an audio-visual device and a method for operating the audio-visual device that can overcome at least some of the above-described drawbacks.

### SUMMARY

It is an object of the present technology to ameliorate at least some of the inconveniences present in the prior art.

According to one aspect of the present technology, there is provided an audio-visual device. The audio-visual device includes a body; a display adjustably connected to the body such that a position of the display can be adjusted relative to the body; a sensor configured to detect the position of the display; at least two speakers housed within the body, one of the at least two speakers being an adjustable speaker communicatively connected to the sensor such that the adjustable speaker is selectively configured based on the position of the display; and at least two microphone arrays, a first of the at least two microphone arrays being positioned on a first section of the display; a second of the at least two microphone arrays being positioned on a second section of the display; and each of the at least two microphone arrays being communicatively connected to the sensor and being selectively enabled based on the position of the display.

In some embodiments, the sensor is a three-axis accelerometer.

In some embodiments, the display is configured to rotate relative to the body between a portrait orientation and a landscape orientation.

In some embodiments, the display is configured to pivot relative to the body between a first display tilt angle and a second display tilt angle.

In some embodiments, the first microphone array is positioned along a longitudinal edge of the display.

In some embodiments, the second microphone array includes a first set of microphones positioned along a lateral edge of the display; and a second set of microphones positioned along a back surface of the display.

In some embodiments, the first set of microphones includes four microphones evenly spaced apart from one another along the lateral edge of the display; and the second set of microphones includes two microphones spaced apart from one another on the back surface of the display.

In some embodiments, the first microphone array is enabled when the position of the display is in a landscape orientation; and the second microphone array is enabled when the position of the display is in a portrait orientation.

In some embodiments, the audio-visual device further including a processor configured to receive the position of the display from the sensor; configure the adjustable speaker based on the received position; and enable one of the at least two microphone arrays based on the received position.

According to another aspect of the present technology, there is provided a method of optimizing audio of an audio-visual device, the method including: detecting, by a sensor, a position of a display relative to a body of the audio-visual device; receiving, by a processor, the position of the display from the sensor; configuring, by the processor, an adjustable speaker of the audio-visual device based on the position of the display; and enabling, by the processor, one of at least two microphone arrays of the audio-visual device based on the position of the display.

In some embodiments, the method further includes adjusting the position of the display relative to the body.

In some embodiments, the adjusting the position of the display relative to the body includes manually adjusting the position of the display.

In some embodiments, the adjusting the position of the display relative to the body includes automatically adjusting the position of the display.

In some embodiments, the method further includes determining, by the processor, a position zone from a plurality of position zones based on the position of the display relative to the body; and where the configuring of the adjustable speaker is based on the determined position zone.

In some embodiments, the plurality of position zones are predetermined.

In some embodiments, a first set of position zones from the plurality of position zones relates to a tilt angle of the display relative to the body when the display is in a landscape orientation; and a second set of position zones from the plurality of position zones relates to the tilt angle of the display relative to the body when the display is in a portrait orientation.

In some embodiments, the method further includes categorizing the tilt angle, by the processor, into a tilt angle ranges from a plurality of tilt angle ranges.

In some embodiments, the method further includes determining an orientation of the display; and where the enabling of the one of at least two microphone arrays of the audio-visual device is based on the orientation of the display.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example “A and/or B” is to be taken as specific disclosure of each of (i) A, (ii) B and (iii) A and B, just as if each is set out individually herein.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a front elevation view of an audio-visual device according to a non-limiting embodiment of the present technology;

FIG. 2 is a perspective view taken from a top, front, left side of the audio-visual device of FIG. 1;

FIG. 3 is a perspective view taken from a bottom, rear, right side of the audio-visual device of FIG. 1;

FIG. 4 is a left elevation view of the audio-visual device of FIG. 1;

FIG. 5 is a top plan view of the audio-visual device of FIG. 1;

FIG. 6 is a perspective view taken from a top, front, left side of the audio-visual device of FIG. 1 showing an interior of the audio-visual device; and

FIG. 7 is a flow chart of a method of operating the audio-visual device.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

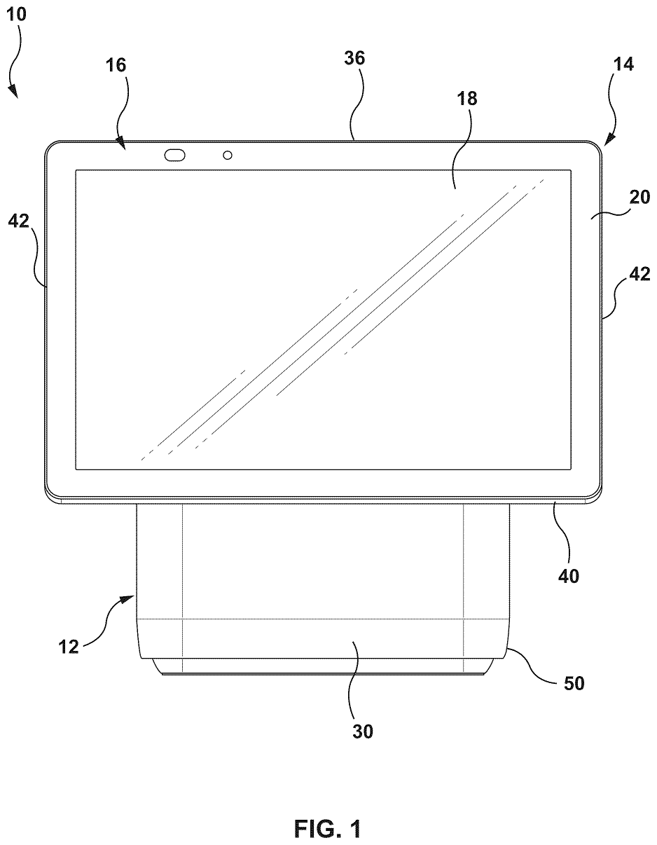

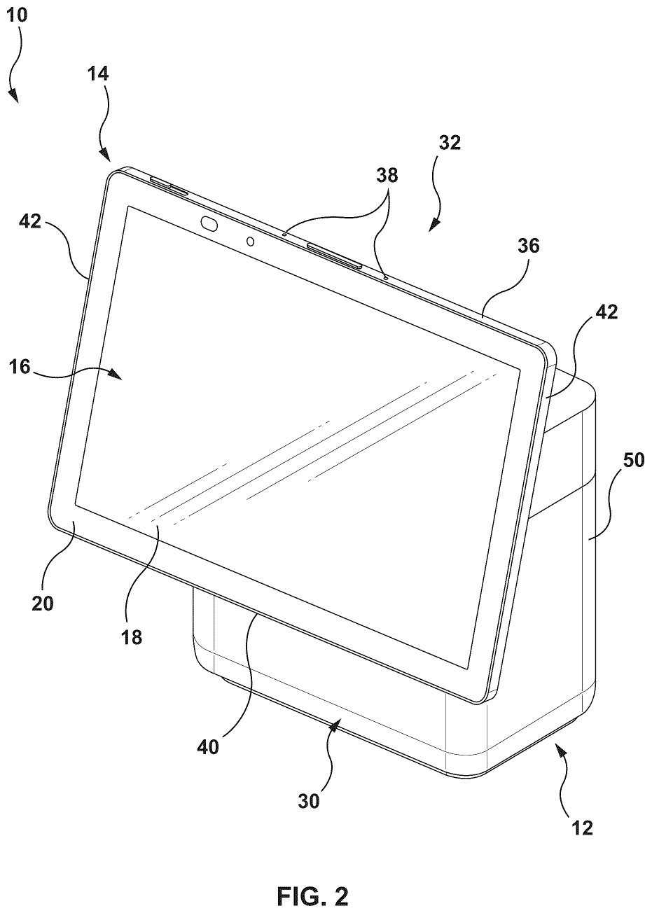

With reference to FIGS. 1 to 6, a non-limiting embodiment of an audio-visual device 10 is depicted. The audio-visual device 10 has a main body 12 and a display 14 connected to the body 12. In the present non-limiting embodiment, the display 14 includes a front face 16 with a flat screen 18 that serves as the visual interface and displays content to a user. The screen 18 is housed within and surrounded by a frame 20. In alternative non-limiting embodiments, the frame 20 may be omitted such that the screen 18 encompasses the entirety of the front face 16 of the display.

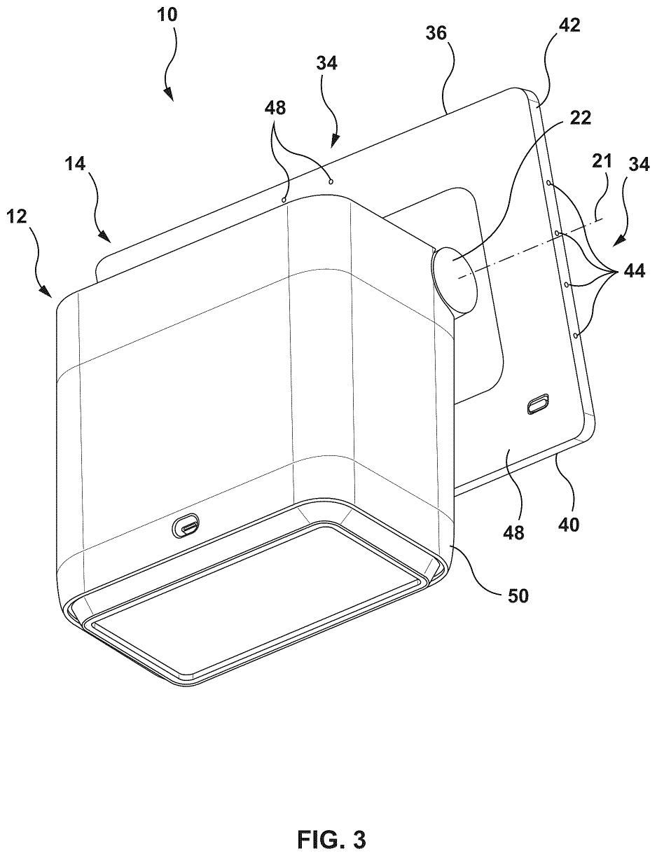

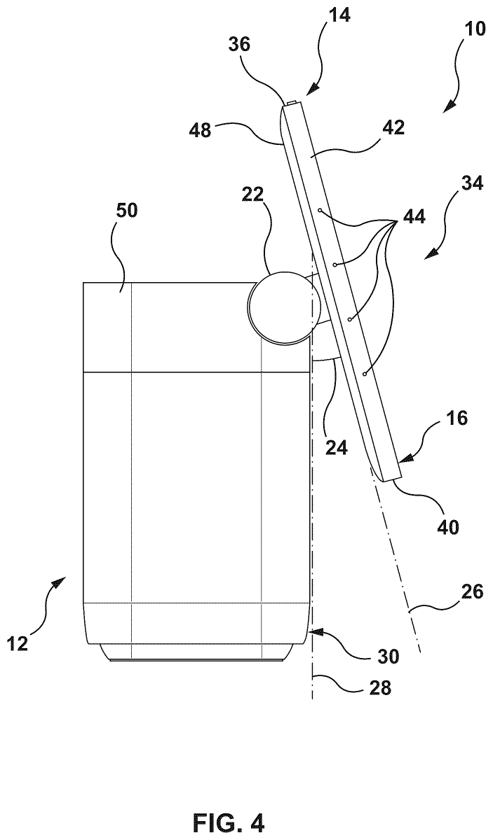

The display 14 is adjustably connected to the body 12, allowing the user to adjust a position of the display 14 relative to the body 12. As depicted in FIGS. 3 and 4, the display 14 is connected to the body 12 via a hinge 22, enabling the user to pivot up and down (i.e., about a horizontal axis 21 defined by the hinge 22). As such, the user may adjust a tilt angle 24 of the display 14. In the present non-limiting embodiment, the tilt angle 24 is defined between a display plane 26, extending parallel to the front face 16 of the display 14, and a body plane 28, extending parallel to a front surface 30 of the body 12. In some non-limiting embodiments, the tilt angle 24 can range from about 0° to 90°. It is contemplated that the range of the tilt angle 24 may vary in other non-limiting embodiments. The display 14 includes a rotation mechanism (not depicted) positioned between the display 14 and the hinge 22 to allow rotation of the display 14 between a landscape orientation and a portrait orientation. In some non-limiting embodiments, the rotation mechanism may include a rotating hinge, ball-and-socket joint, a swivel joint, or any other suitable mechanism. It is noted that, in alternative non-limiting embodiments, the rotation mechanism may be positioned between the display 14 and the body 12. In further alternative non-limiting embodiments, the display 14 may be connected to the body 12 via a joint allowing both tilt and rotation, such as a ball-and-socket joint. It is contemplated that, in certain non-limiting embodiments, the display 14 may be configured to have additional degrees of freedom, for example the display 14 may be able to pivot left and right (i.e., about a vertical axis).

In certain non-limiting embodiments, the display 14 may be manually adjusted by the user. In alternative non-limiting embodiments, the audio-visual device 10 may include a motor operatively connected to the display 14 for automatically adjusting the position of the display 14. In further alternative non-limiting embodiments, the display 14 may be configured to be manually and automatically adjusted.

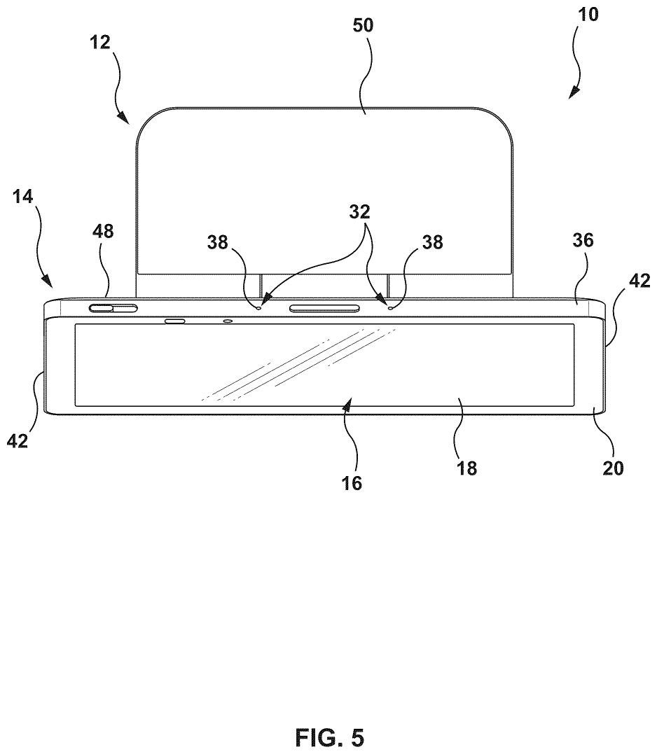

In the present non-limiting embodiment, the audio-visual device 10 further includes two microphone arrays 32, 34. With reference to FIG. 5, a first microphone array 32 includes two microphones 38 spaced apart from one another and positioned along an upper edge 36 of the display 14. The two microphones 38 are positioned 60 mm apart from one another, measured from center to center. In some non-limiting embodiments, the first microphone array 32 may include additional microphones 38 positioned along a lower edge 40 of the display 14. It is contemplated that the number of microphones 38 in the first microphone array 32, as well as the positioning and spacing of the microphones 38 are not limiting and may vary without departing from the scope of the present technology.

With reference to FIGS. 3 and 4, a second microphone array 34 includes two sets of microphones 44, 46. The first set of microphones 44 is positioned along a lateral edge 42 of the display 14. In this non-limiting embodiment, the first set includes four microphones 44 evenly spaced apart at a distance of 27.3 mm, measured center to center. In other non-limiting embodiments, the first set may include additional microphones 44 arranged along the opposite lateral edge 42 of the display. The second set of microphones 46 is positioned along a back face 48 of the display 14. In this non-limiting embodiment, the second set includes two microphones 46 arranged on an upper portion of the back face 48 of the display 14. The microphones 46 are positioned 27.3 mm apart from one another, measured center to center. It is contemplated that, the number of microphones 44, 46, as well as the positioning and spacing of the microphones 44, 46 are not limiting and may vary without departing from the scope of the present technology.

It is noted that, although two microphone arrays 32, 34 are described, any number of microphone arrays 32, 34 may be implemented in alternative non-limiting embodiments. Additionally, the positioning of the microphone arrays 32, 34 may vary in other non-limiting embodiments.

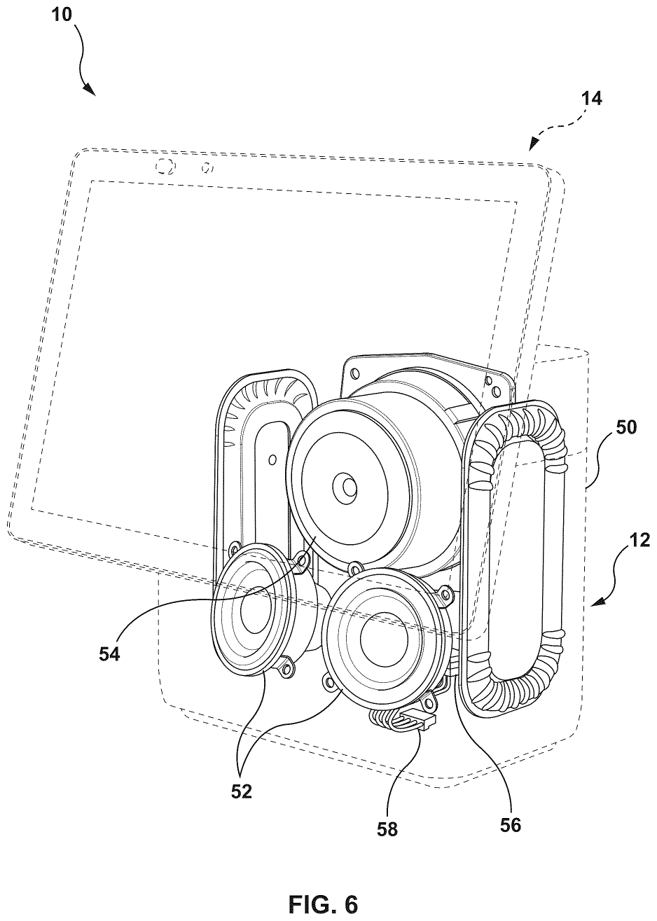

As depicted in FIG. 6, the body 12 includes a housing 50 which houses speakers 52, 54, a processor 56, a sensor 58, and other various electronic components (not separately numbered). In some non-limiting embodiments, the housing 50 may include vents or grilles to allow sound to pass freely from the speakers 52, 54. Additionally, in certain non-limiting embodiments, the housing 50 may be composed of sound-damping materials to enhance audio clarity by minimizing vibrations and echoes.

In the present non-limiting embodiment, the housing 50 houses two speakers 52, 54. One speaker 52 is configured to be selectively enabled based on the position of the display 14 (hereinafter adjustable speaker 52), which will be described in detail below. The other speaker 54 operates continuously, providing a constant audio output (hereinafter constant speaker 54). It is contemplated that the number of adjustable speakers 52 and constant speakers 54 is not limiting and may vary in other non-limiting embodiments.

As mentioned above, the audio-visual device 10 includes the sensor 58. Specifically, the sensor 58 is a position sensor 58 operatively connected to the display 14 for detecting the position of the display 14. In this non-limiting embodiment, the position sensor 58 is a three-axis accelerometer for measuring acceleration along three perpendicular axes (X, Y, and Z), allowing it to detect motion and orientation in all three-dimensional planes. It is contemplated that, in other non-limiting embodiments, other number and type of position sensors used to detect the position of the display 14 may be implemented.

The processor 56 of the audio-visual device 10 is communicatively connected to at least the position sensor 58, each of the microphone arrays 32, 34, and the adjustable speaker 52. In this non-limiting embodiment, the processor 56 is configured to receive a signal from the position sensor 58 indicative of the position of the display 14. Based on the received signal, the processor 56 selectively enables the adjustable speaker 52 and/or one of the microphone arrays 32, 34, which will be described in detail below. It is contemplated that, in other non-limiting embodiments, the processor 56 may be operatively connected to other electronic components, for example a motor configured to adjust the display 14.

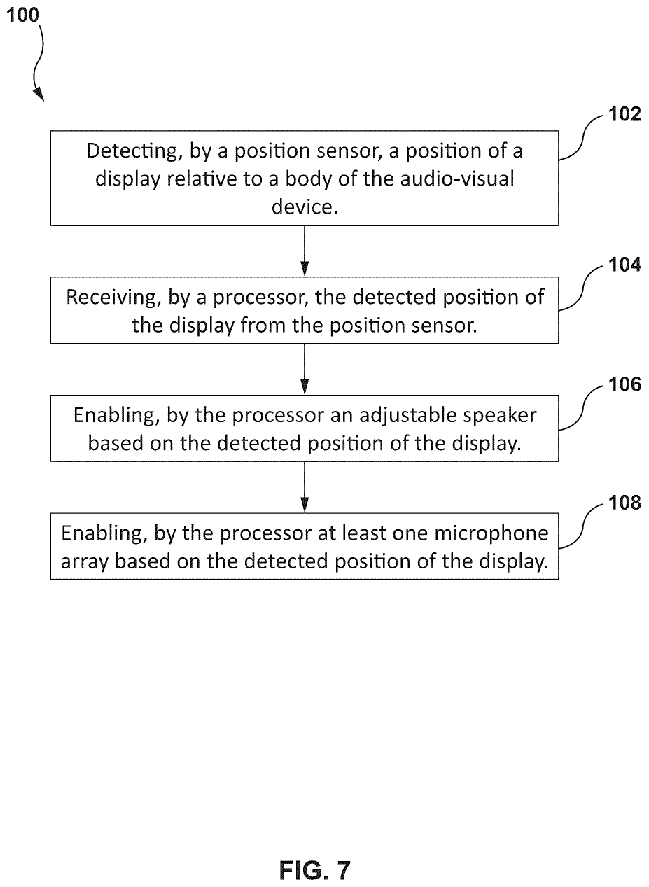

With reference to FIG. 7, a method 100 of operating the audio-visual device 10 will now be described. Broadly, the processor 56 of the audio-visual device 10 is configured to receive the position of display 14 and adjusts the audio inputs and outputs to optimize the performance of the audio-visual device 10. It is noted that the method 100 is exemplary and not limiting, and as such, some steps of the method 100 may be re-ordered and/or omitted without departing from the scope of the present technology.

The method 100 begins with adjusting the position of the display 14 relative to the body 12. In the present non-limiting embodiment, this may involve rotating the display 14 between the landscape orientation and the portrait orientation and/or tilting the display 14 between various tilt angles 18. In some non-limiting embodiments, the display 14 may be manually adjusted by the user. In other non-limiting embodiments, the display 14 may be operatively connected to a motor for automatic adjustment. It is further contemplated that the display 14 may be adjusted both manually and automatically.

At step 102, the method 100 continues with the position sensor 58 detecting the position of the display 14 relative to the body 12. In this non-limiting embodiment, the position sensor 58 is a three-axes accelerometer connected to the display 14. However, it is contemplated that any number or type of position sensor 58 may be implemented.

The method 100 continues, at step 104, with the processor 56 receiving the detected position from the position sensor 58. In the present non-limiting embodiment, the method 100 includes the processor 58 receiving a signal indicative of the orientation and/or the tilt angle 24 of the display 14.

At step 106, the method 100 proceeds with the processor 56 configuring the adjustable speaker 52. Specifically, upon receiving the signal from the position sensor 58, the processor 56 determines the orientation and the tilt angle 24 of the display 14 and based on the received signal adjusts the audio outputs to ensure optimal performance of the audio-visual device 10. In the present non-limiting embodiment, the selective configuring of the adjustable speaker 52 is based on both the orientation of the display 14 and the tilt angle 24 of the display 14. Specifically, upon receiving the signal from the position sensor 58, the processor 56 categorizes the signal into one of six position zones and based on which of the six position zones the signal falls within, the adjustable speaker 52 is selectively enabled.

As described above, the orientation of the display 14 includes the landscape orientation and the portrait orientation. The tilt angle 24 of the display 14 is divided into three tilt ranges (a first range, a second range, and a third range). For example, in some non-limiting embodiments, the first range includes tilt angles 24 falling between 0° to 37.5°, the second range includes tilt angles 24 falling between 37.5° and 52.5°, while the third range includes tilt angles 24 falling between 52.5° and 90°. Thus, defining six position zones, that is two orientations with three tilt sections. The six position zones are predetermined and calibrated during the manufacturing of the audio-visual device 10. It is noted that the number of position zones, as well as how these zones are divided between tilt angle 24 and orientation, is not limiting, and thus the number of position zones may vary in other non-limiting embodiments.

At step 108, the method 100 proceeds with the processor 56 enabling at least one of the two microphone arrays 32, 34. Upon receiving the signal from the position sensor 58, the processor 56 determines the orientation the display 14 and based on the received signal adjusts the audio inputs to ensure optimal performance of the audio-visual device 10. In the present non-limiting embodiment, the selective enabling of the microphone array 32, 34 is based on the orientation of the display 14. If the display 14 is in landscape orientation (i.e., a longitudinal axis of the display 14 is greater than 45° from a vertical axis), the first microphone array 32 (including the microphones 38 positioned along the upper edge 36 of the display 14) is selectively enabled. If the display 14 is in portrait orientation (i.e., the longitudinal axis of the display 14 is less than 45° from the vertical axis), the second microphone array 34 (including the two sets of microphones 44, 46 on the lateral edge 46 and the back face 48 respectively) is selectively enabled. As such, the microphone arrays 32, 34 can be selected to ensure that sound reception is optimized and not obstructed by the position of the display 14. It is contemplated that, in other non-limiting embodiments, other orientations of the display 14 may selectively enable the microphone arrays 32, 34, for example an intermediate orientation (i.e., an orientation which falls in between the landscape and portrait orientations) may cause both microphone arrays 32, 34 to be selectively enabled.

Modifications and improvements to the above-described embodiments of the present technology may become apparent to those skilled in the art. The foregoing description is intended to be exemplary rather than limiting. The scope of the present technology is therefore intended to be limited solely by the appended claims.

What is claimed is:

1. An audio-visual device comprising:
a body;
a display adjustably connected to the body such that a position of the display can be adjusted relative to the body;
a sensor configured to detect the position of the display;
at least two speakers housed within the body, one of the at least two speakers being an adjustable speaker communicatively connected to the sensor such that the adjustable speaker is selectively configured based on the position of the display; and
at least two microphone arrays,
a first of the at least two microphone arrays being positioned on a first section of the display;
a second of the at least two microphone arrays being positioned on a second section of the display; and
each of the at least two microphone arrays being communicatively connected to the sensor and being selectively enabled based on the position of the display.

2. The audio-visual device of claim 1, wherein the sensor is a three-axis accelerometer.

3. The audio-visual device of claim 1, wherein the display is configured to rotate relative to the body between a portrait orientation and a landscape orientation.

4. The audio-visual device of claim 1, wherein the display is configured to pivot relative to the body between a first display tilt angle and a second display tilt angle.

5. The audio-visual device of claim 1, wherein the first microphone array is positioned along a longitudinal edge of the display.

6. The audio-visual device of claim 1, wherein the second microphone array comprises:
a first set of microphones positioned along a lateral edge of the display; and
a second set of microphones positioned along a back surface of the display.

7. The audio-visual device of claim 6, wherein:
the first set of microphones comprises four microphones evenly spaced apart from one another along the lateral edge of the display; and
the second set of microphones comprises two microphones spaced apart from one another on the back surface of the display.

8. The audio-visual device of claim 1, wherein:
the first microphone array is enabled when the position of the display is in a landscape orientation; and
the second microphone array is enabled when the position of the display is in a portrait orientation.

9. The audio-visual device of claim 1, further comprising a processor configured to:
receive the position of the display from the sensor;
configure the adjustable speaker based on the received position; and
enable one of the at least two microphone arrays based on the received position.

10. A method of optimizing audio of an audio-visual device, the method comprising:
detecting, by a sensor, a position of a display relative to a body of the audio-visual device;
receiving, by a processor, the position of the display from the sensor;
configuring, by the processor, an adjustable speaker of the audio-visual device based on the position of the display; and
enabling, by the processor, one of at least two microphone arrays of the audio-visual device based on the position of the display.

11. The method of claim 10, further comprising adjusting the position of the display relative to the body.

12. The method of claim 11, wherein the adjusting the position of the display relative to the body comprises manually adjusting the position of the display.

13. The method of claim 11, wherein the adjusting the position of the display relative to the body comprises automatically adjusting the position of the display.

14. The method of claim 10, further comprising:
determining, by the processor, a position zone from a plurality of position zones based on the position of the display relative to the body; and
wherein:
the configuring of the adjustable speaker is based on the determined position zone.

15. The method of claim 14, wherein the plurality of position zones are predetermined.

16. The method of claim 14, wherein the determining, by the processor, the position zone from the plurality of position zones comprises determining the position zone from six position zones.

17. The method of claim 14, wherein:
a first set of position zones from the plurality of position zones relates to a tilt angle of the display relative to the body when the display is in a landscape orientation; and
a second set of position zones from the plurality of position zones relates to the tilt angle of the display relative to the body when the display is in a portrait orientation.

18. The method of claim 17, further comprising categorizing the tilt angle, by the processor, into a tilt angle ranges from a plurality of tilt angle ranges.

19. The method of claim 10, further comprising:
determining an orientation of the display; and
wherein:
the enabling of the one of at least two microphone arrays of the audio-visual device is based on the orientation of the display.
